(19) United States
(12) Patent Application Publication
(10) Pub. No.: US 2009/0301082 A1
(43) Pub. Date: Dec. 10, 2009

(54) TURBOCHARGER HAVING PISTON-TYPE VARIABLE NOZZLE WITH INTEGRATED ACTUATION SYSTEM

(76) Inventors: Alain Lombard, Uxegney (FR); Patrick Masson, Urimenil (FR); Mary-Jene Ruffinoni, Les Forges (FR); Antoine Jocelyn, Epinal (FR)

Correspondence Address: HONEYWELL TURBO TECHNOLOGIES, 3201 WEST LOMITA BOULEVARD (LAW DEPARTMENT), TORRANCE, CA, 90505, US

(21) Appl. No.: 12/093,771

(22) PCT Filed: Nov. 16, 2005
(86) PCT No.: PCT/US05/41361

§ 371 Date: Jul. 31, 2008

(51) Int. Cl. F02D 23/00

(52) U.S. Cl. 60/602

(57) ABSTRACT

A turbocharger (20) having a sliding piston type variable turbine nozzle includes a tubular piston (40) disposed in a bore (32) of the turbine housing and axially slidable relative to the turbine housing, the piston being slidable between a closed position and an open position for blocking the nozzle (36) opening by an amount dependent on axial positioning of the piston so as to regulate flow into the turbine wheel (30). The turbine housing (32) and piston (40) are structured and arranged to define a cavity (50) therebetween, and there are seals (52a, 52b) between the turbine housing and piston for sealing the cavity, the turbine housing (32) defining a passage (54) connecting with the cavity (50) and adapted to be connected with a fluid source such that application of differential fluid pressure through the passage to the cavity urges the piston to axially slide in the turbine housing.

### BACKGROUND OF THE INVENTION

The present invention relates generally to exhaust gas-driven turbochargers, and relates more particularly to exhaust gas-driven turbochargers having a variable turbine nozzle of the axially sliding piston type for varying the size of the nozzle that leads into the turbine wheel so as to regulate flow into the turbine wheel.

Regulation of the exhaust gas flow through the turbine of an exhaust gas-driven turbocharger provides known operational advantages in terms of improved ability to control the amount of boost delivered by the turbocharger to the associated internal combustion engine. The regulation of exhaust gas flow is accomplished by incorporating variable geometry into the nozzle that leads into the turbine wheel. By varying the size of the nozzle flow area, the flow into the turbine wheel can be regulated, thereby regulating the overall boost provided by the turbocharger's compressor.

Variable-geometry nozzles for turbochargers generally fall into two main categories: variable-vane nozzles, and sliding-piston nozzles. Vanes are often included in the turbine nozzle for directing the exhaust gas into the turbine in an advantageous direction. Typically a row of circumferentially spaced vanes extend axially across the nozzle. Exhaust gas from a chamber surrounding the turbine wheel flows generally radially inwardly through passages between the vanes, and the vanes turn the flow to direct the flow in a desired direction into the turbine wheel. In a variable-vane nozzle, the vanes are rotatable about their axes to vary the angle at which the vanes are set, thereby varying the flow area of the passages between the vanes.

In the sliding-piston type of nozzle, the nozzle may also include vanes, but the vanes are fixed in position. Variation of the nozzle flow area is accomplished by an axially sliding piston that slides in a bore in the turbine housing. The piston is tubular and is located just radially inwardly of the nozzle. Axial movement of the piston is effective to vary the axial extent of the nozzle opening leading into the turbine wheel. When vanes are included in the nozzle, the piston can slide adjacent to radially inner (i.e., trailing) edges of the vanes; alternatively, the piston and vanes can overlap in the radial direction and the piston can include slots for receiving at least a portion of the vanes as the piston is slid axially to adjust the nozzle opening.

Actuation of the piston is one of the challenges of designing a sliding piston type of variable nozzle. Typically the piston is actuated by a mechanical linkage that is coupled to the piston and is operated by a suitable actuator device such as a vacuum chamber actuator or the like. There are two primary types of piston actuator linkages. In one type, a downstream end of the piston is connected to arms that extend axially rearward and radially inwardly toward the piston axis and the arms connect with a rod of an actuator device disposed outside the turbine housing, the rod penetrating through the turbine housing in the axial direction. This is disadvantageous because the arms and actuator rod are disposed in the exhaust gas flow stream, and their presence in the flow creates aerodynamic disturbances, degrading turbocharger performance.

The second type of piston actuator linkage employs a fork-shaped swing arm that of generally semi-circular configuration that is positioned adjacent one side of the piston and that has two arm portions that engage the outer surface of the piston at two diametrically opposite locations. The swing arm is pivoted about an axis transverse to the piston axis to cause the swing arm to translate the piston in the axial direction of the piston.

Both of these types of piston actuator linkages are mechanically complex, and the former type can lead to a performance penalty as noted. There is a need for an improved system for actuating a piston in a variable nozzle of a turbocharger.

### BRIEF SUMMARY OF THE INVENTION

The present invention addresses the above needs and achieves other advantages, by providing a turbocharger having a sliding piston type variable nozzle wherein actuation of the piston is accomplished by differential fluid pressure without any mechanical linkage and without aerodynamic disturbances that can degrade turbocharger performance. In accordance with one embodiment of the invention, a turbocharger comprises a center housing containing a bearing assembly and a rotary shaft mounted in the bearing assembly, a compressor wheel affixed to one end of the shaft and disposed in a compressor housing coupled to one side of the center housing, and a turbine wheel affixed to an opposite end of the shaft and disposed in a bore of a turbine housing coupled to an opposite side of the center housing, the bore extending in an axial direction. The turbine housing defines a chamber surrounding the turbine wheel for receiving exhaust gas to be directed into the turbine wheel, the chamber defining a nozzle opening leading into the turbine wheel. The turbocharger further comprises a tubular piston disposed in the bore of the turbine housing and axially slidable relative to the turbine housing, the piston being slidable between a closed position and an open position for blocking the nozzle opening by an amount dependent on axial positioning of the piston so as to regulate flow into the turbine wheel. The turbine housing and piston are structured and arranged to define a cavity therebetween, and there are seals between the turbine housing and piston for sealing the cavity, the turbine housing defining a passage connecting with the cavity and adapted to be connected with a fluid source such that application of differential fluid pressure through the passage to the cavity urges the piston to axially slide in the turbine housing. The differential pressure can be either positive (i.e., pressurized) or negative (i.e., vacuum).

The turbocharger can further comprise a biasing device arranged between the piston and turbine housing for biasing the piston in one direction. The application of differential fluid pressure to the cavity urges the piston in the opposite direction against the force of the biasing device. For example, in one embodiment the biasing device urges the piston toward its open position and the application of differential fluid pressure to the cavity urges the piston toward its closed position. Alternatively, however, the piston and turbine housing can be structured and arranged such that application of differential fluid pressure opens the piston and the biasing device closes the piston.

Alternatively, the biasing device can be omitted, and the restoring force for returning the piston to either the closed or open position can be provided by fluid pressure.

In one embodiment, the turbine housing bore has an upstream bore portion of relatively smaller diameter and a downstream bore portion of relatively greater diameter, with a step transitioning from the upstream bore portion to the downstream bore portion. The piston has an upstream piston portion of relatively smaller outer diameter in sealing engagement with the upstream bore portion, and a downstream piston portion of relatively greater outer diameter in sealing engagement with the downstream bore portion, with a step transitioning from the upstream piston portion to the downstream piston portion. The cavity is defined between the downstream bore portion and the upstream piston portion and is delimited in the axial direction by the steps in the piston and turbine housing bore. The biasing device advantageously comprises a compression spring disposed between the steps in the piston and turbine housing bore.

Also encompassed by the present invention is a sliding piston assembly for a turbocharger, wherein the turbocharger has a turbine wheel affixed to an end of a shaft and disposed in a cylindrical cavity of a turbine housing, the cylindrical cavity extending in an axial direction, the turbine housing defining a chamber surrounding the turbine wheel for receiving exhaust gas to be directed into the turbine wheel, the chamber defining a nozzle opening leading into the turbine wheel, the sliding piston assembly comprising:

a tubular insert axially insertable into the cylindrical cavity of the turbine housing, the tubular insert having a radially inner surface defining a bore through the tubular insert; and

a tubular piston disposed in the bore of the tubular insert and axially slidable relative to the tubular insert, the piston being slidable between a closed position and an open position for blocking the nozzle opening by an amount dependent on axial positioning of the piston so as to regulate flow into the turbine wheel. The tubular insert and piston are structured and arranged to define a cavity therebetween, and there are seals between the tubular insert and piston for sealing the cavity. The tubular insert defines a passage connected with the cavity and adapted to be connected with a fluid source such that application of differential fluid pressure through the passage to the cavity urges the piston to axially slide in the tubular insert.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a cross-sectional view of a turbocharger in accordance with one embodiment of the invention, wherein the piston is closed;

FIG. 2 is a view similar to FIG. 1, with the piston partially open; and

FIG. 3 is a view similar to FIG. 1, with the piston fully open.

### DETAILED DESCRIPTION OF THE INVENTION

The present inventions now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

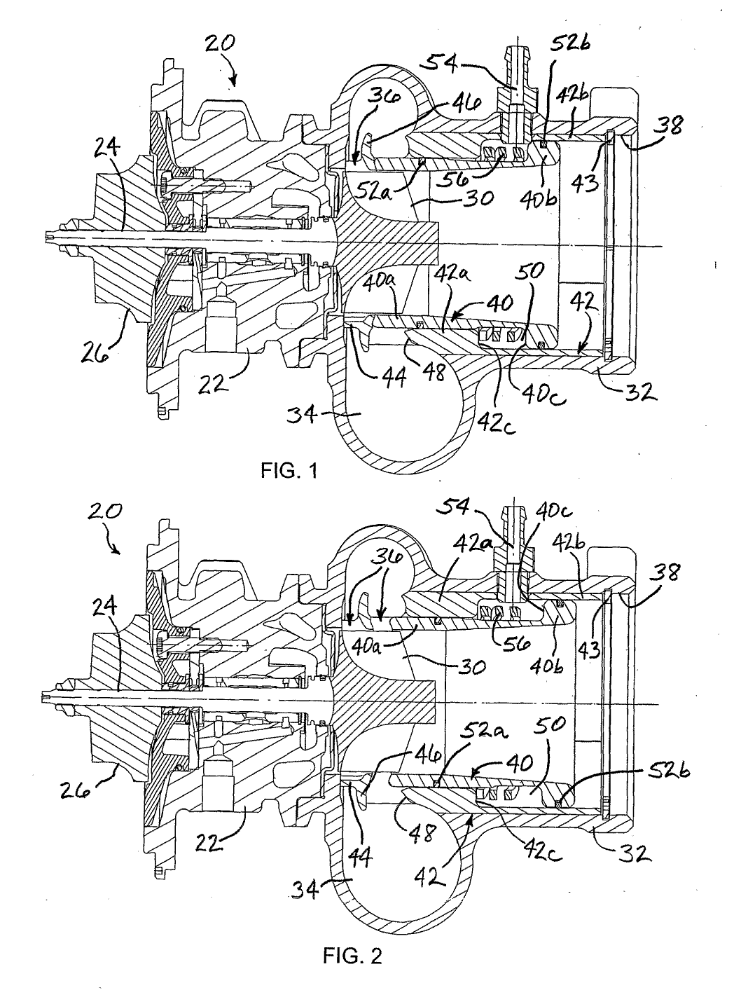

FIGS. 1 through 3 depict a turbocharger 20 in accordance with one embodiment of the invention. The turbocharger includes a center housing 22 that housing bearings (not shown) for a rotatable shaft 24 of the turbocharger. A compressor wheel 26 is mounted on one end of the shaft 24 and is housed in a compressor housing (not shown) that is attached to one side of the center housing 22. A turbine wheel 30 is mounted on the opposite end of the shaft 24 and is housed in a turbine housing 32. The turbine housing defines a generally annular chamber 34 that surrounds the turbine wheel and receives engine exhaust gas for driving the turbine wheel. The exhaust gas flows generally radially inwardly from the chamber 34 through a nozzle 36 defined by the turbine housing and other components (as further described below) and flows through the turbine wheel, which turns the flow toward an axial direction.

The turbine housing 32 defines an axially extending bore or cavity 38 in which the turbine wheel 30 resides at an upstream end of the cavity. The exhaust gas that has flowed through the wheel is discharged through a downstream end of the cavity 38. The cavity 38 in the illustrated embodiment is cylindrical.

A piston 40 is mounted in the cavity 38 of the turbine housing such that the piston is axially slidable relative to the turbine housing. The piston is tubular in configuration. The piston is disposed between the nozzle 36 and the turbine wheel 30, and is movable to various axial positions for regulating the size of the nozzle flow area through which exhaust gas can flow from the chamber 34 to the turbine wheel. The turbocharger includes a tubular insert 42 that concentrically surrounds the piston 40 and is disposed in the cavity 38 between the piston and the inner surface of the turbine housing 32. The insert 42 is inserted into the cavity 38 and held in place by a snap ring 43 that engages a groove in the inner surface of the turbine housing 32. The piston 40 is received within the insert 42 and is slidable relative to the insert. An array of circumferentially spaced vanes 44 is mounted on the insert 42 at the end of the insert proximate the turbine wheel 30. The vanes 44 are positioned to extend partway across the axial extent of the nozzle 36. The insert also includes a ring or flange 46 that separates the row of vanes 44, which forms a first portion of the nozzle 36, from a second portion of the nozzle defined by openings 48 through the wall of the insert 42.

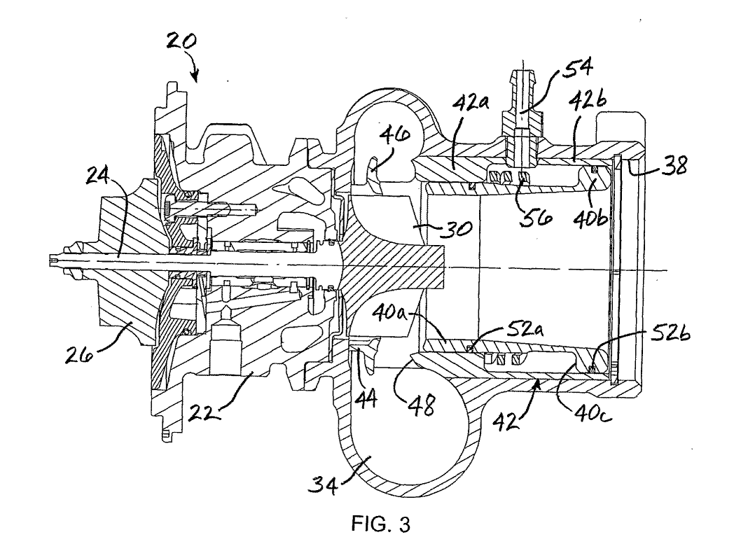

In a closed position of the piston 40, an upstream end of the piston is abutting or closely proximate to the ring 46 as shown in FIG. 1, and accordingly the exhaust gas that flows through the nozzle is constrained to flow through the array of vanes 44. In an open position of the piston, the upstream end of the piston is spaced from the ring 46 as in FIGS. 2 and 3, in which case some of the exhaust gas flows through the vanes 44 and an additional amount of exhaust gas flows through the openings 48 defined in the insert 42. The closed position of the piston thus provides a relatively greater amount of flow restriction than does the open position. Adjustment of the piston position can be used for regulating the flow into the turbine wheel, thereby regulating the overall boost provided by the turbocharger to an internal combustion engine to which the turbocharger is coupled.

In accordance with the invention, the actuation of the piston 40 in the closing direction is accomplished using differential fluid pressure that acts directly on the piston. More specifically, the insert 42 and piston 40 are structured and arranged to define a cavity 50 therebetween. In the illustrated embodiment, the insert 42 has an upstream portion 42a of relatively smaller inside diameter and a downstream portion 42b of greater inside diameter. Correspondingly, the piston has an upstream portion 40a of smaller outside diameter and a downstream portion 40b of greater outside diameter. The cavity 50 is defined between the smaller-diameter upstream portion 40a of the piston and the larger-diameter downstream portion 42b of the insert. The piston defines an upstream-facing step surface 40c and the insert defines a downstream-facing step surface 42c, these step surfaces delimiting the cavity 50 in the axial direction. There is a seal 52a between the upstream portion 40a of the piston and the upstream portion 42a of the insert, and a second seal 52b between the downstream portion 40b of the piston and the downstream portion 42b of the insert, for sealing the cavity 50. The turbine housing defines a passage 54 connecting with the cavity 50 and adapted to be connected with a vacuum source such that application of vacuum through the passage 54 to the cavity 50 urges the piston to axially slide in the upstream direction (i.e., toward the closed position) in the turbine housing bore, as illustrated in FIG. 1.

A compression spring 56 is disposed between the piston 40 and the insert 42 for urging the piston toward the closed position. More particularly, the spring is disposed in the cavity 50 and is compressed between the step surfaces 42c and 40c. The spring 56 thus acts on the piston in an opposite direction to that of the fluid pressure when vacuum is exerted on the cavity 50. When enough vacuum is exerted to overcome the spring force on the piston, the piston moves toward the closed position. The movement of the piston in the closed direction ceases either when the spring force and the fluid force become equal or when the piston reaches its fully closed position (FIG. 1) in which the piston abuts the ring 46 of the insert 42. When vacuum is removed, the spring urges the piston to the open position (FIG. 3). Various partially open piston positions can be achieved by suitably regulating the degree of vacuum exerted on the cavity 50 so that the spring force and fluid force balance each other at different points of the full piston stroke.

The embodiment of FIGS. 1-3 employs the insert 42 such that the cavity 50 is defined between the insert and the piston 40, but it will be understood that alternatively the piston can directly engage the inner surface of the turbine housing and the cavity can be defined between the piston and the turbine housing inner surface. In other words, the turbine housing 32 and insert 42 essentially comprise a two-piece turbine housing, but alternatively a one-piece turbine housing can be used.

It will also be understood that the arrangement of FIGS. 1-3 can be reversed, in that the cavity 50 can be structured and arranged so that the force of the spring 56 closes the piston and the vacuum in the cavity 50 opens the piston. For example, the turbine housing cavity 38 (or the bore of an insert of the turbine housing) can have an upstream portion of greater diameter and a downstream portion of smaller diameter, and the piston can have an upstream portion of greater outside diameter and a downstream portion of smaller outside diameter, and the cavity can be defined between the larger-diameter portion of the bore and the smaller-diameter portion of the piston. It is also within the scope of the invention to employ positive differential fluid pressure applied to the cavity 50 for moving the piston, rather than negative differential fluid pressure (i.e., vacuum).

The insert 42 and the piston 40 together comprise a sliding piston assembly that is axially insertable into the cavity 38 of the main turbine housing member 32 and securable therein by the snap ring 43, thereby facilitating assembly of the turbocharger.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A turbocharger having a variable nozzle, comprising:
a center housing containing a bearing assembly and a rotary shaft mounted in the bearing assembly;
a compressor wheel affixed to one end of the shaft adjacent one side of the center housing;
a turbine wheel affixed to an opposite end of the shaft and disposed in a bore of a turbine housing coupled to an opposite side of the center housing, the bore extending in an axial direction, the turbine housing defining a chamber surrounding the turbine wheel for receiving exhaust gas to be directed into the turbine wheel, the chamber defining a nozzle opening leading into the turbine wheel;
a tubular piston disposed in the bore of the turbine housing and axially slidable relative to the turbine housing, the piston being slidable between a closed position and an open position for blocking the nozzle opening by an amount dependent on axial positioning of the piston so as to regulate flow into the turbine wheel; and
the turbine housing and piston being structured and arranged to define a cavity therebetween, and further comprising seals between the turbine housing and piston for sealing the cavity, the turbine housing defining a passage connected with the cavity and adapted to be connected with a fluid source such that application of differential fluid pressure through the passage to the cavity urges the piston to axially slide in the turbine housing.

2. The turbocharger of claim 1, further comprising a biasing device connected between the piston and the turbine housing and operable to apply a force urging the piston in a first direction within the bore of the turbine housing, application of differential fluid pressure through the passage to the cavity urging the piston to axially slide in the turbine housing in a second direction opposite to the first direction against the force of the biasing device.

3. The turbocharger of claim 2, wherein the cavity is arranged such that application of vacuum thereto causes the piston to be slid toward the closed position, and the biasing device is arranged to urge the piston toward the open position.

4. The turbocharger of claim 3, wherein the turbine housing bore has an upstream bore portion of relatively smaller diameter and a downstream bore portion of relatively greater diameter, with a step transitioning from the upstream bore portion to the downstream bore portion, and the piston has an upstream piston portion of relatively smaller outer diameter in sealing engagement with the upstream bore portion, and a downstream piston portion of relatively greater outer diameter in sealing engagement with the downstream bore portion, with a step transitioning from the upstream piston portion to the downstream piston portion, the cavity being defined between the upstream bore portion and the downstream piston portion and delimited in the axial direction by the steps in the piston and turbine housing bore.

5. The turbocharger of claim 4, wherein the biasing device comprises a compression spring disposed between the steps in the piston and turbine housing bore.

6. The turbocharger of claim 1, further comprising vanes mounted so as to extend at least partway across the nozzle opening.

7. The turbocharger of claim 1, wherein the turbine housing is formed as two separate members, one of the members comprising a main turbine housing member defining a cylindrical cavity, and the other of the members comprising a tubular insert that is axially inserted into the cylindrical cavity of the main turbine housing member and secured therein, a radially inner surface of the tubular insert defining the bore within which the piston slides.

8. The turbocharger of claim 7, wherein the insert is secured in the main turbine housing member by a snap ring.

9. A sliding piston assembly for a turbocharger having a variable nozzle, wherein the turbocharger comprises a turbine wheel affixed to an end of a shaft and disposed in a cylindrical cavity of a turbine housing, the cylindrical cavity extending in an axial direction, the turbine housing defining a chamber surrounding the turbine wheel for receiving exhaust gas to be directed into the turbine wheel, the chamber defining a nozzle opening leading into the turbine wheel, the sliding piston assembly comprising:
a tubular insert axially insertable into the cylindrical cavity of the turbine housing, the tubular insert having a radially inner surface defining a bore through the tubular insert; and
a tubular piston disposed in the bore of the tubular insert and axially slidable relative to the tubular insert, the piston being slidable between a closed position and an open position for blocking the nozzle opening by an amount dependent on axial positioning of the piston so as to regulate flow into the turbine wheel;
the tubular insert and piston being structured and arranged to define a cavity therebetween, and further comprising seals between the tubular insert and piston for sealing the cavity, the tubular insert defining a passage connected with the cavity and adapted to be connected with a fluid source such that application of differential fluid pressure through the passage to the cavity urges the piston to axially slide in the tubular insert.

10. The sliding piston assembly of claim 9, further comprising a biasing device connected between the piston and the tubular insert and operable to apply a force urging the piston in a first direction within the bore of the tubular insert, application of differential fluid pressure through the passage to the cavity urging the piston to axially slide in the tubular insert in a second direction opposite to the first direction against the force of the biasing device.

11. The sliding piston assembly of claim 10, wherein the cavity is arranged such that application of vacuum thereto causes the piston to be slid toward the closed position, and the biasing device is arranged to urge the piston toward the open position.

12. The sliding piston assembly of claim 1, wherein the tubular insert has an upstream bore portion of relatively smaller diameter and a downstream bore portion of relatively greater diameter, with a step transitioning from the upstream bore portion to the downstream bore portion, and the piston has an upstream piston portion of relatively smaller outer diameter in sealing engagement with the upstream bore portion, and a downstream piston portion of relatively greater outer diameter in sealing engagement with the downstream bore portion, with a step transitioning from the upstream piston portion to the downstream piston portion, the cavity being defined between the upstream bore portion and the downstream piston portion and delimited in the axial direction by the steps in the piston and tubular insert.

13. The sliding piston assembly of claim 12, wherein the biasing device comprises a compression spring disposed between the steps in the piston and tubular insert.

14. The sliding piston assembly of claim 9, further comprising vanes mounted on the tubular insert so as to extend at least partway across the nozzle opening.
